(19) United States
(12) Patent Application Publication
(10) Pub. No.: US 2017/0150848 A1
(43) Pub. Date: Jun. 1, 2017

(54) SUPPLIMENTAL TANK FOR COOKING DEVICE

(71) Applicant: STEPHEN L. ENGBERS, Martinsville, IN (US)

(72) Inventor: STEPHEN L. ENGBERS, Martinsville, IN (US)

(21) Appl. No.: 14/747,323

(22) Filed: Aug. 20, 2015

Related U.S. Application Data
(60) Provisional application No. 62/015,694, filed on Jun. 23, 2014.

(51) Int. Cl. A47J 37/07; F17C 1/00; F24C 3/14

(52) U.S. Cl. CPC A47J 37/0786; F24C 3/14; F17C 1/00; F17C 2205/0373; F17C 2201/058

(57) ABSTRACT

This invention is the use of two products and coupling them in a package to “rescue” the back Yard gas griller when their 20 lb. propane tank runs out of gas or doesn't function properly.

### BACKGROUND AND SUMMARY

Backyard gas grillers have been running out of propane in the middle of cooking since gas grills were invented. This product allows the backyard gas griller to complete their cooking when they run out of propane without having to either stop cooking and go to the store to replace the 20 lb tank OR finish cooking in the kitchen.

This invention is the packaging of two entities: a 1 lb tank and an adapter that fits both the 1 lb propane tank and the regulator on the gas grill (the empty 20 lb tank side of the propane tank). This product is designed to be used when the normal 20 lb propane tank runs out of gas and you can substitute with the 1 lb tank with the adapter in minutes.

The 1 lb propane tank is non refillable, weighs 16.4 oz (1.02 lb) while the special adapter has both a male and female threads on one end to fit the regulator on the grill and female threads with a tip to fit the 1 lb propane tank.

The invention is the packaging of both the 1 lb propane tank and the adapter. The packaging will be two fold: one package group will couple the 1 lb propane tank with the adapter in a blister pack. This type packaging for out door display at outlets that sell the 20 lb exchange tanks. We will also package the 1 lb tank with the adapter in a box so it can be shipped vis USPS to customers homes and thru retail outlets.

### BRIEF DESCRIPTION OF DRAWINGS

The invention will be better understood and more apparent when consideration is given to the following and the detailed description to follow. Such description makes reference to the drawings within:

FIG. 1, shows the 1 lb propane tank

FIG. 2, shows the adapter

FIG. 3, shows plastic blister pack container

FIG. 4, shows card board box container

### DETAILED DESCRIPTION OF DRAWINGS

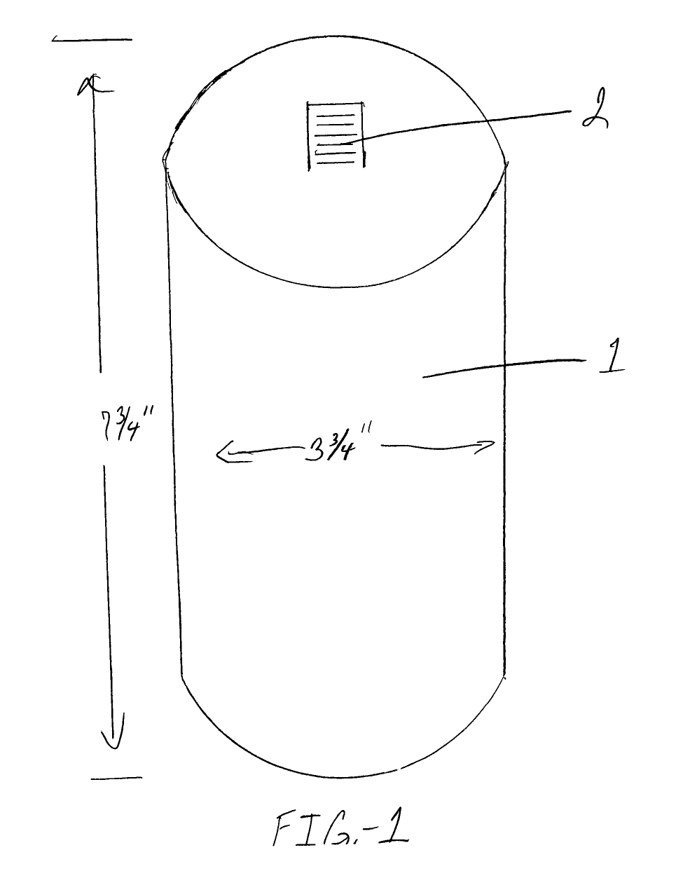

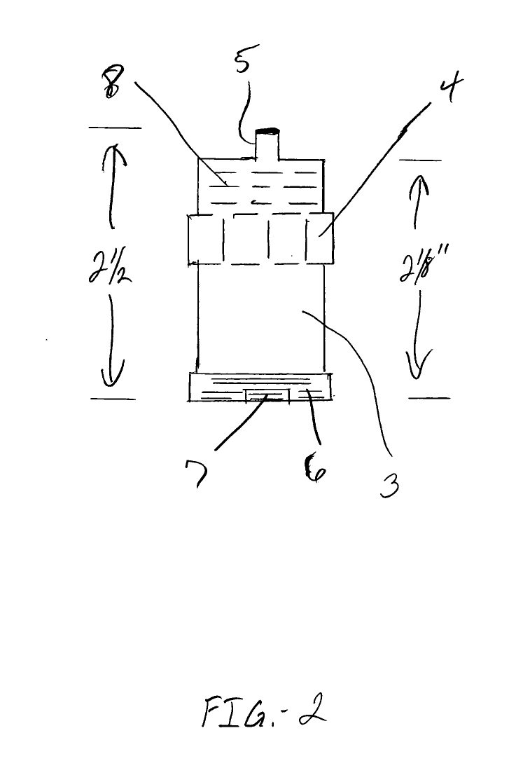

PROPANE TANK. The numerical 2, refers to threads that FIG. 2, number 2 punctures as number 5 is threaded into FIG. 1, number 2.

With respect to FIG. 2, numerical 3 refers to the adapter. Numerical 4 refers to the nut that tightens adapter, number 5 is the tip that protrudes into FIG. 1, number 2. Number 6 is exterior male threads and number 7 is interior female threads. Both type threads are needed, depending upon what type is used with respect to the grill regulator to which this is attached. Numerical 8 are female threads that attach to FIG. 1, number 2.

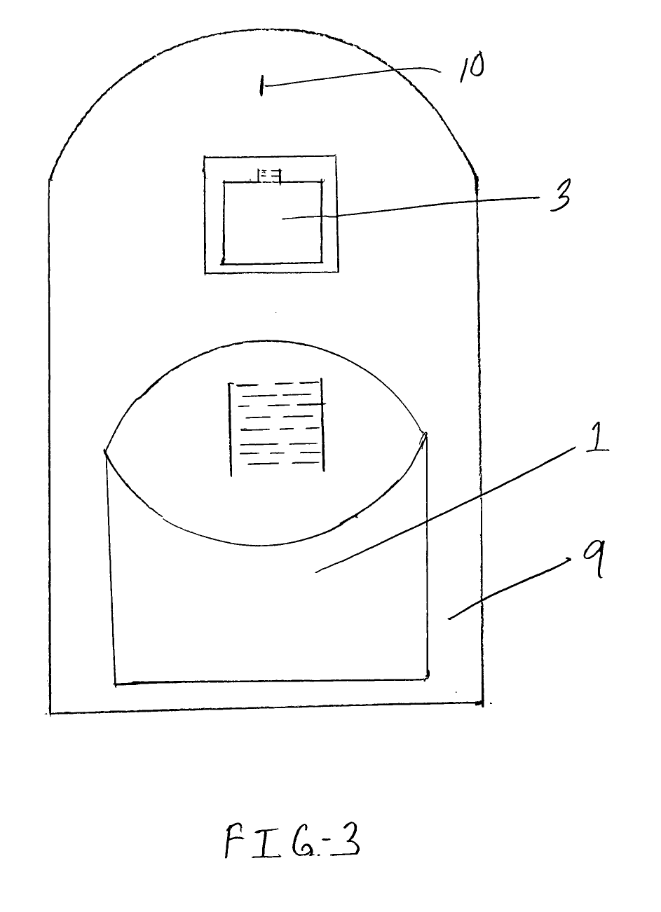

With respect to FIG. 3, is numbers 1, 2 and 3 are referred to earlier. Numerical 9, makes reference to a plastic blister pack container. Number 10, refers to a slot in the plastic to be hung for display purposes.

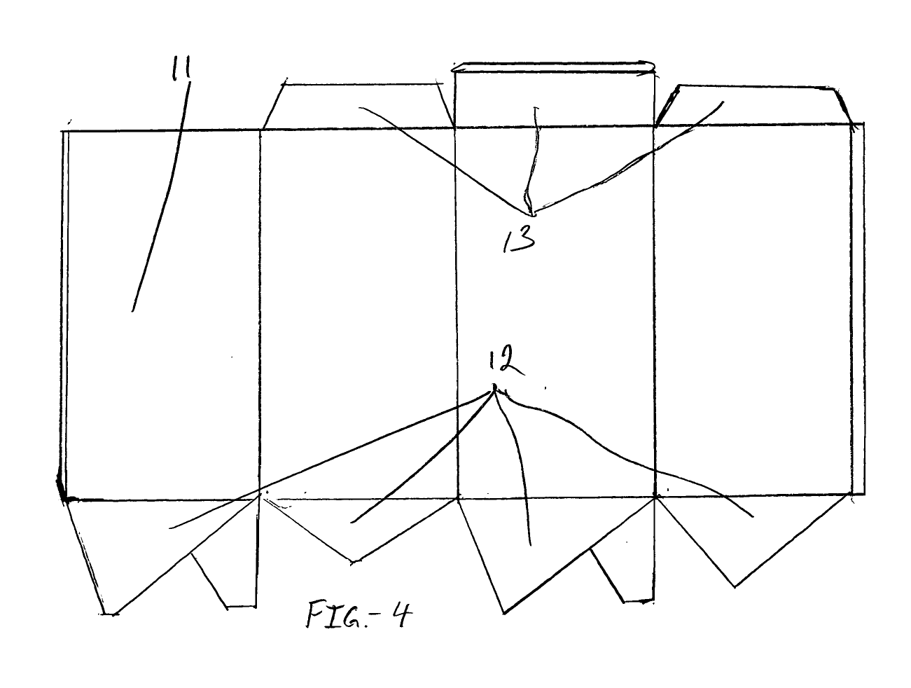

With respect to FIG. 4, numerical 11, makes reference to the card board box container. Number 12, refers to the bottom of the box and number 13 refers to the top of the box.

1. A Propane tank assembly including a propane tank, a multi-threaded adapter and packaging coupling the propane tank to the multi-threaded adapter including
one end having both a male and female threads adapted to to fit a grill regulator and the other end having female threads to fit the propane tank and a protruding tip that enables a user to continue gas grilling when another propane tank used for the grilling runs out of propane.
